(19) United States
(12) Patent Application Publication
(10) Pub. No.: US 2023/0209200 A1
(43) Pub. Date: Jun. 29, 2023

(54) CAMERA MODULE

(71) Applicant: SAMSUNG ELECTRO-MECHANICS CO., LTD., Suwon-si (KR)

(72) Inventors: Jung Hyun PARK, Suwon-si (KR); Ju Ho KIM, Suwon-si (KR); Sang Hyun JI, Suwon-si (KR); Nam Keun OH, Suwon-si (KR); Doo Seub SHIN, Suwon-si (KR); Do Hwan KIM, Suwon-si (KR); Dong Hoon LEE, Suwon-si (KR)

(73) Assignee: SAMSUNG ELECTRO-MECHANICS CO., LTD., Suwon-si (KR)

(21) Appl. No.: 18/073,114

(22) Filed: Dec. 1, 2022

(30) Foreign Application Priority Data
Dec. 27, 2021 (KR) 10-2021-0188373

(51) Int. Cl. H04N 23/68; G02B 27/64; G03B 5/00; H04N 23/54

(52) U.S. Cl. CPC H04N 23/687; G02B 27/646; G03B 5/00; H04N 23/54; G03B 2205/0007

(57) ABSTRACT

A camera module includes a fixed frame having an internal space, a movable frame installed in the internal space of the fixed frame to be movable, with at least one optical member mounted thereon, and a driving wire including a wire member formed of a shape-memory alloy, and two coupling members coupled to the wire member and formed in a wedge shape, wherein the fixed frame includes a first wire coupling portion disposed to protrude toward the movable frame, and the movable frame includes a second wire coupling portion disposed to protrude toward the fixed frame, and the two coupling members of the driving wire are inserted into the first wire coupling portion and the second wire coupling portion, respectively, to connect the movable frame and the fixed frame to each other.

### CROSS-REFERENCE TO RELATED APPLICATIONS

This application claims the benefit under 35 USC 119(a) of Korean Patent Application No. 10-2021-0188373 filed on Dec. 27, 2021, in the Korean Intellectual Property Office, the entire disclosure of which is incorporated herein by reference for all purposes.

### BACKGROUND

### 1. Field

The present disclosure relates to a camera module.

### 2. Description of the Background

Cameras may be adopted not only in smartphones but also in other portable electronic devices such as tablet personal computers (PCs) and laptop PCs, and an auto-focusing function, an optical image stabilization function, a zoom function, and the like have been added to cameras for mobile terminals.

However, in order to implement various functions, structures of camera modules have become complicated, and sizes of camera modules have increased, resulting in a problem that sizes of portable electronic devices, on which the camera modules are mounted, have increased accordingly.

With the growth of the smartphone camera market, attempts have been continuously made to miniaturize and integrate the functions of conventional general manual cameras, such as auto-focusing (AF) and optical zoom, along with an OIS driving method. According to the structural diversification, there has been a demand for OIS driving methods other than the conventional OIS method.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a fixed frame having an internal space, a movable frame installed in the internal space of the fixed frame to be movable, with at least one optical member mounted thereon, and a driving wire including a wire member formed of a shape-memory alloy, and two coupling members coupled to the wire member and formed in a wedge shape, wherein the fixed frame includes a first wire coupling portion disposed to protrude toward the movable frame, and the movable frame includes a second wire coupling portion disposed to protrude toward the fixed frame, and the two coupling members of the driving wire are inserted into the first wire coupling portion and the second wire coupling portion, respectively, to connect the movable frame and the fixed frame to each other.

The wire member may be disposed in parallel with a movement direction of the movable frame.

The coupling members may include a first coupling member inserted into the first wire coupling portion and a second coupling member inserted into the second wire coupling portion, each of the coupling members being formed to have a cross-sectional area that decreases toward one side thereof, and the first coupling member and the second coupling member may be coupled to the wire member in such a manner that respective portions having small cross sections thereof face each other.

The first wire coupling portion, the second wire coupling portion, and the driving wire may be formed of a conductive material.

Each of the coupling members may include a tubular member formed in a conical pipe shape, and a filling member filled in the tubular member, and the wire member may be fixed to the coupling member by penetrating through the filling member.

Each of the first and second wire coupling portions may include an insertion space in a through-hole form to allow a corresponding one of the coupling members to be inserted thereinto, and the insertion space may have a cross-sectional area that decreases toward one side thereof.

The fixed frame may include a wiring electrically connecting the first wire coupling portion to an external element.

The movable frame may include a wiring electrically connecting the second wire coupling portion to the fixed frame.

The movable frame may include a seating portion on which the optical member is mounted, and an elastic support portion disposed between the seating portion and the fixed frame and elastically deformed as the movable frame moves to provide a restoring force to the seating portion.

The elastic support portion may include a pillar portion extending from the seating portion toward the fixed frame, a deformable portion extending from the pillar portion in parallel with the seating portion, and a protruding portion extending from an end of the deformable portion toward the fixed frame.

The protruding portion may remain in contact with the fixed frame regardless of whether or not the movable frame moves.

The optical member may include an image sensor, a lens barrel, or an image sensor and a lens barrel.

The camera module may further include a cable electrically connecting the driving wire to an external element.

The first wire coupling portion and the second wire coupling portion may be disposed to be spaced apart from each other by a predetermined distance in a movement direction of the movable frame.

In another general aspect, a camera module may include a fixed frame having an internal space, a movable frame installed to be linearly movable in the internal space of the fixed frame, and a driving wire including a wire member formed of a shape-memory alloy, and two coupling members fastened to the wire member, wherein any one of the two coupling members is coupled to the fixed frame, and the other one of the two coupling members is coupled to the movable frame, each of the coupling members is formed to have a cross-sectional area that decreases toward one side thereof, and the two coupling members are disposed in such a manner that respective portions having small cross sections thereof face each other.

The camera module may further include a wiring connected to the driving wire for use as an electrical path for applying a current to the wire member.

In another general aspect, an optical image stabilizer (OIS) includes a first wire coupler disposed on a fixed frame and comprising a first tapered insertion space, a second wire coupler disposed on a movable body and comprising a second insertion space tapered toward the first wire coupler, a shape memory alloy wire comprising a first tapered coupler and a second tapered coupler spaced apart from each other and tapered toward each other, wherein the first tapered insertion space is tapered toward the second tapered insertion space, wherein the first and second tapered couplers are engaged in the first and second tapered insertion spaces, respectively, and wherein when a current flows through the shape memory alloy wire, the shape memory alloy wire changes shape, moving the movable body in a direction to bring the first and second wire couplers closer to each other.

Each of the first and second couplers may include a tube formed in a conical pipe shape, and a filler filled in the tube, and the shape memory alloy wire may be fixed to the first and second couplers by penetrating through the respective fillers.

The OIS may further include an elastic support disposed between the movable body and the fixed frame that elastically deforms as the movable body moves to provide a restoring force to the movable body.

A camera module may include the OIS, and an optical member disposed on the movable body, wherein the optical member may include an image sensor, a lens barrel, or an image sensor and a lens barrel.

Other features and aspects will be apparent from the following detailed description, the drawings, and the claims.

### BRIEF DESCRIPTION OF DRAWINGS

FIG. 1 is a perspective view illustrating a portable electronic device according to an example embodiment in the present disclosure.

FIG. 2 is a perspective view of a camera module illustrated in FIG. 1.

FIG. 3 is an exploded perspective view of the camera module illustrated in FIG. 2.

FIG. 4 is a plan view of the camera module illustrated in FIG. 2.

FIG. 5 is an exploded perspective view of a driving wire and a wire coupling portion illustrated in FIG. 2.

FIG. 6 is a partial cross-sectional view of the driving wire and the wire coupling portion illustrated in FIG. 2.

FIG. 7 is a perspective view illustrating a camera module according to another example embodiment in the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may provide a camera module that is easy to manufacture while having high operational reliability.

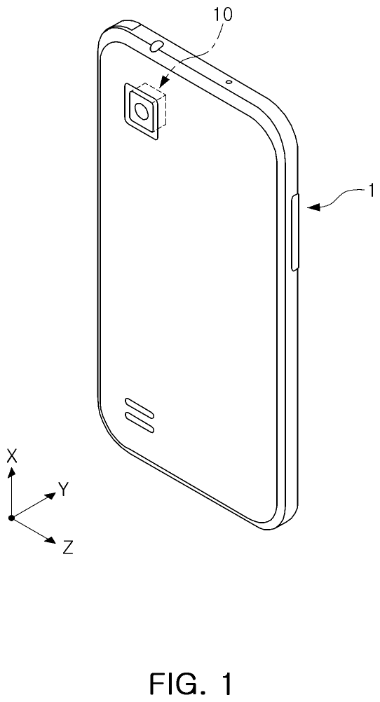

FIG. 1 is a perspective view illustrating a portable electronic device according to an example embodiment in the present disclosure.

Referring to FIG. 1, a portable electronic device 1 according to an example embodiment in the present disclosure may be a portable electronic device on which a camera module 10 is mounted, such as a mobile communication terminal, a smartphone, or a tablet PC.

As illustrated in FIG. 1, the camera module 10 may be mounted on the portable electronic device 1 to photograph a subject.

In the present example embodiment, the camera module 10 may include a plurality of lenses, and may be disposed such that an optical axis (a Z-axis) of each of the lenses is a thickness direction of the portable electronic device 1 (a Y-axis direction, a direction from a front surface to a rear surface of the portable electronic device, or an opposite direction thereof). However, the camera module 10 is not limited thereto.

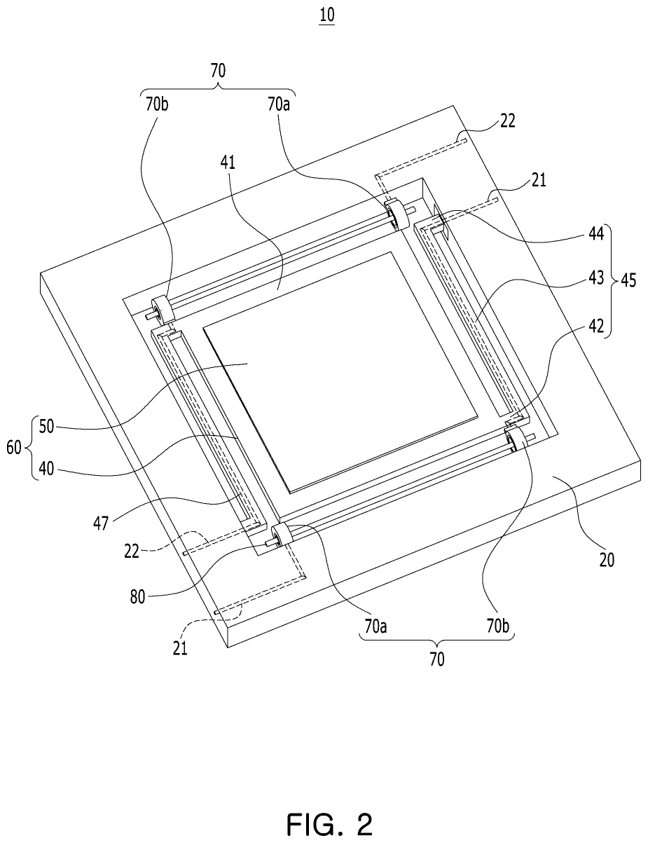

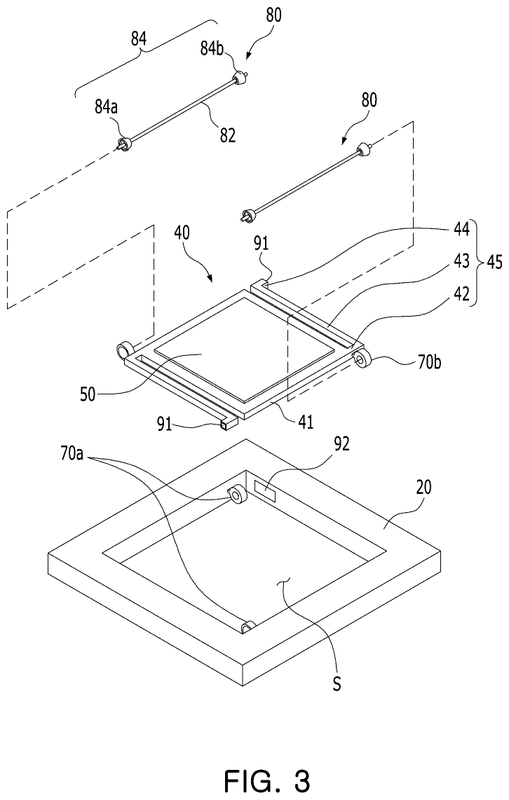

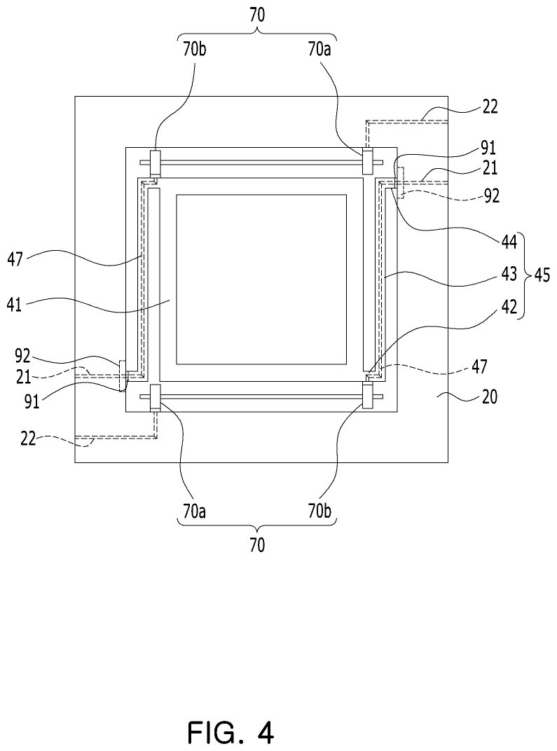

FIG. 2 is a perspective view of the camera module illustrated in FIG. 1, FIG. 3 is an exploded perspective view of the camera module illustrated in FIG. 2, and FIG. 4 is a plan view of the camera module illustrated in FIG. 2. For convenience of description, in FIGS. 2 through 4, the camera module is illustrated with the lenses being omitted.

Referring to FIGS. 2 through 4 together, the camera module 10 according to the present example embodiment may include a fixed frame 20, a movable body 60, and a driving wire 80.

The fixed frame 20 may have an internal space S. For example, the fixed frame 20 may be formed as a rectangular frame of which upper and lower sides are open.

The fixed frame 20 may be formed of an insulating material, and may accommodate the movable body 60, which will be described below, in the internal space S described above.

A size or shape of the internal space S of the fixed frame 20 may be defined according to a size or shape of the movable body 60. For example, the internal space S of the fixed frame 20 may be sized such that the movable body 60 is movable by a certain distance therein.

In addition, as illustrated in FIG. 4, the fixed frame 20 of the present example embodiment may include a first wiring 21 and a second wiring 22.

The first wiring 21 may be provided to electrically connect a third wiring 47 of a movable frame 40, which will be described below, to an external element (e.g., an actuator). To this end, a second contact terminal 92 may be provided at a portion contacting a protruding portion 44 of the movable frame 40 on an inner surface of the fixed frame 20 facing the movable frame 40, and one end of the third wiring 47 may be connected to the second contact terminal 92. The second contact terminal 92 may be formed of a conductive material, and may be disposed in a position facing the protruding portion 44 of the movable frame 40.

The second wiring 22 may be provided to electrically connect a first wire coupling portion 70a, which will be described below, to an external element. To this end, one end of the second wiring 22 may be connected to the first wire coupling portion 70a and the other end of the second wiring 22 may be connected to an external element on the fixed frame 20. Here, the external element may include a power supply device for applying a current to the driving wire 80 or an actuator.

In the present example embodiment, the first and second wirings 21 and 22 may be formed by embedding conductive members such as metal frames in the fixed frame 20. However, the configuration of the present disclosure is not limited thereto. Various modifications may be made to the first and second wirings 21 and 22, for example, by forming conductive patterns on a surface of the fixed frame 20 for use as the first and second wirings 21 and 22.

The first wire coupling portion 70a may be provided on the inner surface of the fixed frame 20. This will be explained together with the movable frame 40 below.

The movable body 60 may be installed to be movable in the internal space S of the fixed frame 20. Therefore, the movable body 60 may be sized to be inserted into the internal space S of the fixed frame 20.

The movable body 60 may include an optical member 50 and a movable frame 40.

The optical member 50 is a member disposed on an optical path, and may include at least one of an image sensor and a lens barrel. In the present example embodiment, the optical member 50 includes an image sensor to which light is finally incident.

The optical member 50 may be fixedly coupled to the movable frame 40, and move together with the movable frame 40 as the movable frame 40 moves.

The movable frame 40 may be disposed to be able to move linearly in at least one direction in the internal space S of the fixed frame 20.

To this end, the movable frame 40 may include a seating portion 41, an elastic support portion 45, and a second wire coupling portion 70b.

At least one optical member 50 may be mounted on the seating portion 41. Therefore, the seating portion 41 may be formed in an area capable of supporting the optical member 50, and the seating portion 41 may be disposed to be entirely spaced apart from the fixed frame 20 by a certain distance.

In the present example embodiment, the seating portion 41 may be formed in a quadrangular plate shape. However, the configuration of the present disclosure is not limited thereto, and the shape of the seating portion 41 may be modified variously as long as the movable frame 40 is movable in the internal space S of the fixed frame 20.

The elastic support portion 45 may be disposed between the seating portion 41 and the fixed frame 20 and elastically deformed as the movable frame 40 moves to provide a restoring force to the seating portion 41.

In the present example embodiment, one end of the elastic support portion 45 may be formed in cantilever spring form on the seating portion 41.

For example, the elastic support portion 45 may include a pillar portion 42 extending from the seating portion 41 toward the fixed frame 20, and a deformable portion 43 extending from the pillar portion 42 in parallel with the seating portion 41. One end of the deformable portion 43 may be fastened to the pillar portion 42.

The protruding portion 44 may be provided at the other end of the deformable portion 43. The protruding portion 44 may be formed to protrude toward the fixed frame 20 to contact the fixed frame 20. In the present example embodiment, the protruding portion 44 may remain in contact with the fixed frame 20 regardless of whether or not the movable frame 40 moves.

A first contact terminal 91 may be provided at an end of the protruding portion 44 contacting the fixed frame 20. Accordingly, when the protruding portion 44 comes into contact with the fixed frame 20, the first contact terminal 91 may be electrically and physically connected to the second contact terminal 92.

Since the elastic support portion 45 is configured as described above, when the movable frame 40 moves toward the fixed frame 20, the deformable portion 43 may be bent and elastically deformed. Accordingly, an elastic restoring force generated from the deformable portion 43 may be applied to the seating portion 41.

In the present example embodiment, two elastic support portions 45 are provided on both sides of the seating portion 41. For example, the two elastic support portions 45 may be disposed in opposite directions with respect to the seating portion 41. Accordingly, the two elastic support portions 45 may be disposed on one straight line along a direction in which the movable frame 40 moves.

As described above, the protruding portion 44 may be disposed to contact the fixed frame 20. Therefore, if no external force acts on the movable frame 40, the movable frame 40 may be suppressed from shaking in the fixed frame 20. On the other hand, if an external force is applied to the movable frame 40, at least one of the elastic support portions 45 may be elastically deformed, and accordingly, the seating portion 41 may move in a first direction or in a second direction.

In the present example embodiment, the first direction refers to a direction in which the seating portion 41 approaches the fixed frame while one of the elastic support portions 45 is elastically deformed, and the second direction refers to a direction opposite to the first direction.

In addition, the movable frame 40 of the present example embodiment may include a third wiring 47. The third wiring 47 may be provided to electrically connect the second wire coupling portion 70b, which will be described below, to the first wiring 21 of the fixed frame 20. To this end, one end of the third wiring 47 may be connected to the second wire coupling portion 70b, and the other end of the third wiring 47 may be connected to the first contact terminal 91 formed at the protruding portion 44 through the elastic support portion 45.

The first contact terminal 91 and the second contact terminal 92 need to remain electrically connected to each other regardless of whether or not the movable frame 40 moves, and thus, it is advantageous that the first contact terminal 91 and the second contact terminal 92 are continuously kept in a contact state. However, when the elastic support portion 45 is elastically deformed, the position of the first contact terminal 91 may also be changed. In order to keep the electrical connection between the first contact terminal 91 and the second contact terminal 92 regardless of whether or not the first contact terminal 91 moves, the second contact terminal 92 may be formed to have an area larger than a movement range of the first contact terminal 91.

In the present example embodiment, the third wiring 47 is formed by embedding a conductive member such as a metal frame in the movable frame 40. However, the configuration of the present disclosure is not limited thereto. Various modifications may be made to the third wiring 47, for example, by forming a conductive pattern on a surface of the movable frame 40 for use as the third wiring 47.

The fixed frame 20 and the movable frame 40 may include wire coupling portions 70.

The wire coupling portions 70 may include a first wire coupling portion 70a fixedly fastened to the fixed frame 20, and a second wire coupling portion 70b fixedly coupled to the movable frame 40.

The wire coupling portions 70 to which the driving wire 80, which will be described below, is coupled may be arranged in such a manner that one first wire coupling portion 70a and one second wire coupling portion 70b form a pair. The fixed frame 20 of the present example embodiment includes two first wire coupling portions 70a. Accordingly, the movable frame 40 may also include two second wire coupling portions 70b.

The first wire coupling portion 70a and the second wire coupling portion 70b forming a pair are disposed to be spaced apart from each other by a predetermined distance. In this case, the first wire coupling portion 70a and the second wire coupling portion 70b may be spaced apart from each other by a predetermined distance in the movement direction of the movable frame 40.

In addition, the first wire coupling portion 70a and the second wire coupling portion 70b may be disposed in a space between the seating portion 41 and the fixed frame 20, and may be disposed on one straight line parallel to the movement direction of the movable frame 40. To this end, the first wire coupling portion 70a fastened to the fixed frame 20 may protrude toward the movable frame 40, and the second wire coupling portion 70b fastened to the movable frame 40 may protrude toward the fixed frame 20.

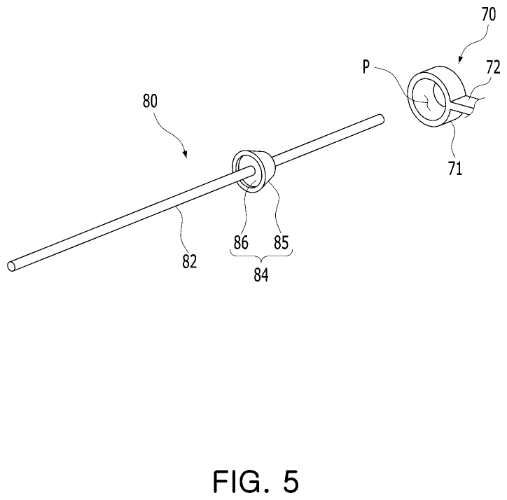

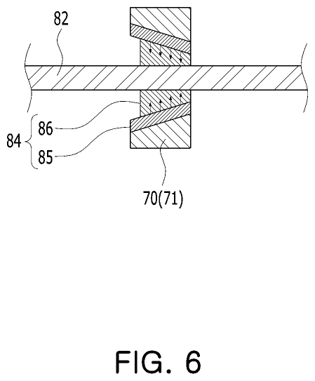

FIG. 5 is an exploded perspective view of the driving wire and the wire coupling portion illustrated in FIG. 2, and FIG. 6 is a partial cross-sectional view of the driving wire and the wire coupling portion illustrated in FIG. 2.

Referring to FIGS. 5 and 6 together, each of the wire coupling portions 70 may include an insertion ring 71 formed in a circular annular shape, and a fixing portion 72 connecting the insertion ring 71 to the fixed frame 20 or the movable frame 40.

The insertion ring 71 may have an insertion space P in a through-hole form, and a coupling member 84, which will be described below, may be inserted and coupled into the insertion space P. As illustrated in FIG. 6, the insertion space P of the insertion ring 71 may be formed to have a cross-sectional area that decreases toward one side thereof.

In addition, as illustrated in FIG. 3, the cross-sectional area of the insertion space P may decrease in a direction in which the first wire coupling portion 70a and the second wire coupling portion 70b, which form a pair, become closer to each other. For example, the cross-sectional area of the insertion space P in the second wire coupling portion 70b may decrease toward the first wire coupling portion 70a, and the cross-sectional area of the insertion space P in the first wire coupling portion 70a may decrease toward the second wire coupling portion 70b.

To this end, in the present example embodiment, the insertion space P of the insertion ring 71 may be formed in a conical shape with a trapezoidal cross section. However, the configuration of the present disclosure is not limited thereto.

In the present example embodiment, the insertion ring 71 is formed in a doughnut shape. However, the configuration of the present disclosure is not limited thereto. Various modifications may be made to the insertion ring 71 as long as the coupling member 84, which will be described below, can be fixedly coupled thereto, for example, by forming the insertion ring 71 as a partially cut ring.

The fixing portion 72 may be integrally formed with the insertion ring 71, one end of the fixing portion 72 may be connected to an outer circumferential surface of the insertion ring 71, and the other end of the fixing portion 72 may be connected to the fixed frame 20 or the movable frame 40.

In the present example embodiment, the wirings 21, 22, and 47 provided in the movable frame 40 and the fixed frame 20 and the wire coupling portions 70 may be used as an electrical path for applying a current to the driving wire 80. To this end, the wire coupling portions 70 may be formed of a conductive material such as metal, and electrically connect the wiring 21, 22, and 47 provided in the movable frame 40 and the fixed frame 20 to the driving wire 80, which will be described below.

The driving wire 80 is coupled to each of the first wire coupling portion 70a and the second wire coupling portion 70b, which form a pair, to connect the movable frame 40 and the fixed frame 20 to each other. Therefore, the first wire coupling portion 70a and the second wire coupling portion 70b to be mentioned in the following description refer to wire coupling portions 70 connected to one driving wire 80, that is, forming a pair.

In the present example embodiment, a plurality of driving wires 80 may be provided, and each of the driving wires 80 may include a wire member 82 and a coupling member 84.

The wire member 82 may be formed of a wire having a predetermined level of rigidity, and may be formed of a shape-memory alloy. Therefore, when a temperature of the wire member 82 is changed by a current applied to the wire member 82, a length of the wire member 82 may be changed.

Since the driving wire 80 connects the first wire coupling portion 70a and the second wire coupling portion 70b to each other, the wire member 82 may be formed to have a length larger than a distance by which the first wire coupling portion 70a and the second wire coupling portion 70b are spaced apart from each other. In addition, the wire member 82 may be disposed in parallel with the movement direction of the movable frame 40.

The coupling member 84 is integrally coupled to the wire member 82. The coupling member 84 may be inserted into the insertion space P of the insertion ring 71 described above. Therefore, the driving wire 80 may be formed by coupling two coupling members 84 to one wire member 82.

The coupling members 84 may include a first coupling member 84a inserted into any one of the first and second wire coupling portions 70a and 70b, and a second coupling member 84b inserted into the other one of the first and second wire coupling portions 70a and 70b.

Since the coupling member 84 is inserted into the insertion ring 71, an outer shape of the coupling member 84 may be formed to correspond to an inner shape of the insertion ring 71. For example, the coupling member 84 may be formed to have a cross-sectional area that decreases toward one side thereof. In the present example embodiment, the first coupling member 84a and the second coupling member 84b may be coupled to the wire member 82 in such a manner that respective portions having small cross sections thereof face each other. For example, the cross-sectional areas of the two coupling members 84a and 84b coupled to one wire member 82 may decrease in a direction in which the two coupling members 84a and 84b become closer to each other.

The coupling member 84 of the present example embodiment may be formed in a conical shape with a trapezoidal cross section to correspond to the shape of the insertion space P of the insertion ring 71. In addition, the wire member 82 may be coupled to the coupling member 84 by penetrating through the center of the coupling member 84. However, the configuration of the present disclosure is not limited thereto, and the shape of the coupling member 84 may be variously modified as long as the coupling member 84 can be inserted into the insertion space P of the insertion ring 71 to suppress movement thereof.

The coupling member 84 of the present example embodiment may include a tubular member 85 formed in a conical pipe shape, and a filling member 86 filled in the tubular member 85. Then, the wire member 82 may be fixed to the filling member 86 by penetrating through the filling member 86. Therefore, the wire member 82 may be disposed to be spaced apart from the tubular member 85 by a predetermined distance, and the filling member 86 may be disposed between the wire member 82 and the tubular member 85 to connect the wire member 82 and the tubular member 85 to each other.

The filling member 86 may be formed by filling a conductive material such as a conductive adhesive inside the tubular member 85 and curing the conductive material. As an example, the filling member 86 may be disposed inside the tubular member 85 through the following steps: applying a liquid conductive member to the wire member 82 and pre-curing the conductive member; coupling the tubular member 85 to the wire member 82; disposing the tubular member 85 in such a manner that the pre-cured conductive material is located inside the tubular member 85; and completely curing the conductive member.

As another example, the filling member 86 may be disposed inside the tubular member 85 through the following steps: coupling the wire member 82 to the tubular member 85; filling a liquid conductive material in an internal space of the tubular member 85; and completely curing the conductive material.

In the present example embodiment, the driving wire 80 is entirely formed of a conductive material. To this end, both the tubular member 85 and the filling member 86 may be formed of a conductive material, and the wire member 82 may be electrically connected to the wirings 21, 22, and 47 through the filling member 86 and the tubular member 85.

In the present example embodiment, the wire member 82 is formed in a straight-line shape, but the configuration of the present disclosure is not limited thereto. In order to increase a coupling force between the coupling member 84 and the wire member 82, various modifications may be made to the wire member 82 if necessary, for example, by configuring the driving wire 80 in such a manner that the wire member 82 is wound around the tubular member 85 at least once, or by forming at least one knot on the wire member 82 located in the filling member 86.

In the driving wire 80 configured as described above, two coupling members 84 disposed to be spaced apart from each other by a predetermined distance may be coupled to the first wire coupling portion 70a and the second wire coupling portion 70b, respectively. Accordingly, when the length of the wire member 82 is reduced by applying a current to the driving wire 80 or blocking the current applied to the driving wire 80, a distance between the first wire coupling portion 70a and the second wire coupling portion 70b is reduced.

At this time, since the first wire coupling portion 70a is fixed to the fixed frame 20, the second wire coupling portion 70b fixed to the movable frame 40 moves toward the first wire coupling portion 70a. Accordingly, the movable frame 40, to which the second wire coupling portion 70b is coupled, may move in the first direction or in the second direction.

When the movable frame 40 moves in the first direction or in the second direction, the elastic support portion 45 provided in the movement direction of the movable frame 40 is elastically deformed, and as a result, a restoring force is generated. Therefore, when the length of the wire member 82 is restored to its original state, the movable frame 40 may return to its original position due to the restoring force of the elastic support portion 45 described above.

In the camera module 10 of the present example embodiment described above, as a larger tension is applied to the wire member 82 of the driving wire 80, a larger force is applied to the coupling member 84 in a direction to be in closer contact with the wire member 82 (see the arrows in FIG. 6), thereby increasing a coupling force between the coupling member 84 and the wire member 82. As a result, high coupling reliability can be provided. In addition, since the extent to which the wire member 82 is stretched can be controlled by controlling a current, precise measurement on the tension of the wire member 82 can be omitted in a manufacturing process, thereby making the manufacturing process very easy and minimizing the occurrence of defects.

Meanwhile, the present disclosure is not limited to the above-described example embodiment, and various modifications made be made.

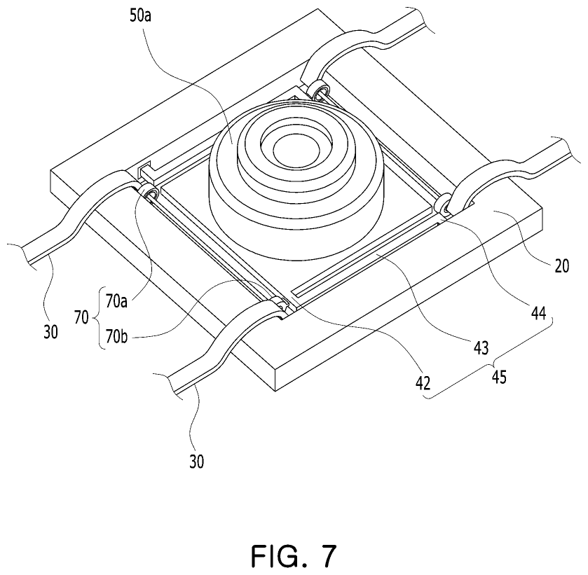

FIG. 7 is a perspective view illustrating a camera module according to another example embodiment in the present disclosure.

Referring to FIG. 7, the camera module of the present example embodiment includes a lens barrel as an optical member 50a.

The lens barrel may include at least one lens disposed on a light path. The lens barrel may be fixedly installed on the seating portion 41 of the movable frame 40, and thus, the seating portion 41 of the movable frame 40 may function as a lens holder to which the lens barrel is fixed.

In this case, the seating portion 41 may have a hole through which light having passed through the lens barrel passes, and an image sensor may be disposed at the rear of the seating portion 41 with respect to the light path.

The above-described image sensor of FIG. 2 may be used as an image sensor, but the configuration of the present disclosure is not limited thereto.

In the present example embodiment, the movable frame 40 and the fixed frame 20 may be configured similarly to those in the above-described example embodiment. However, in the camera module of the present example embodiment, cables 30 may be used instead of the wirings of the above-described example embodiment.

The cables 30 may electrically connect both ends of the wire member 82 to external elements. Therefore, in this case, wirings may be omitted in the movable frame 40 and the fixed frame 20, and the wire coupling portions 70 may also be formed of an insulating material rather than the conductive material.

As the cable 30, a general insulating cable may be used or a board-type cable such as a flexible PCB (FPCB) may be used.

As set forth above, according to the example embodiments in the present disclosure, the camera module is capable of having high coupling reliability between the moving frame and the fixed frame connected to each other by the driving wire. As a result, OIS operational reliability can be increased.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

For example, in the above-described example embodiments, the elastic support portion may be formed in a cantilever spring form. However, various spring forms other than the cantilever spring form, such as a leaf spring, a coil spring, a spiral spring, a wheel spring, a clockwork spring, and a disc spring, may be applied to the elastic support portion. Also, an elastic body based on rubber, fluid, or the like may be used.

What is claimed is:

1. A camera module comprising:
a fixed frame having an internal space;
a movable frame installed in the internal space of the fixed frame to be movable, with at least one optical member mounted thereon; and
a driving wire including a wire member formed of a shape-memory alloy, and two coupling members coupled to the wire member and formed in a wedge shape,
wherein the fixed frame includes a first wire coupling portion disposed to protrude toward the movable frame, and the movable frame includes a second wire coupling portion disposed to protrude toward the fixed frame, and
the two coupling members of the driving wire are inserted into the first wire coupling portion and the second wire coupling portion, respectively, to connect the movable frame and the fixed frame to each other.

2. The camera module of claim 1, wherein the wire member is disposed in parallel with a movement direction of the movable frame.

3. The camera module of claim 2, wherein the coupling members include a first coupling member inserted into the first wire coupling portion and a second coupling member inserted into the second wire coupling portion, each of the coupling members being formed to have a cross-sectional area that decreases toward one side thereof, and
the first coupling member and the second coupling member are coupled to the wire member in such a manner that respective portions having small cross sections thereof face each other.

4. The camera module of claim 1, wherein the first wire coupling portion, the second wire coupling portion, and the driving wire are formed of a conductive material.

5. The camera module of claim 1, wherein each of the coupling members includes a tubular member formed in a conical pipe shape, and a filling member filled in the tubular member, and
wherein the wire member is fixed to the coupling member by penetrating through the filling member.

6. The camera module of claim 1, wherein each of the first and second wire coupling portions includes an insertion space in a through-hole form to allow a corresponding one of the coupling members to be inserted thereinto, and
wherein the insertion space has a cross-sectional area that decreases toward one side thereof.

7. The camera module of claim 1, wherein the fixed frame includes a wiring electrically connecting the first wire coupling portion to an external element.

8. The camera module of claim 1, wherein the movable frame includes a wiring electrically connecting the second wire coupling portion to the fixed frame.

9. The camera module of claim 1, wherein the movable frame includes:
a seating portion on which the optical member is mounted; and
an elastic support portion disposed between the seating portion and the fixed frame and elastically deformed as the movable frame moves to provide a restoring force to the seating portion.

10. The camera module of claim 9, wherein the elastic support portion includes:
a pillar portion extending from the seating portion toward the fixed frame;
a deformable portion extending from the pillar portion in parallel with the seating portion; and
a protruding portion extending from an end of the deformable portion toward the fixed frame.

11. The camera module of claim 10, wherein the protruding portion remains in contact with the fixed frame regardless of whether or not the movable frame moves.

12. The camera module of claim 1, wherein the optical member includes an image sensor, a lens barrel, or an image sensor and a lens barrel.

13. The camera module of claim 1, further comprising a cable electrically connecting the driving wire to an external element.

14. The camera module of claim 1, wherein the first wire coupling portion and the second wire coupling portion are disposed to be spaced apart from each other by a predetermined distance in a movement direction of the movable frame.

15. A camera module comprising:
a fixed frame having an internal space;
a movable frame installed to be linearly movable in the internal space of the fixed frame; and
a driving wire including a wire member formed of a shape-memory alloy, and two coupling members fastened to the wire member,
wherein any one of the two coupling members is coupled to the fixed frame, and the other one of the two coupling members is coupled to the movable frame,
wherein each of the coupling members is formed to have a cross-sectional area that decreases toward one side thereof, and
wherein the two coupling members are disposed in such a manner that respective portions having small cross sections thereof face each other.

16. The camera module of claim 15, further comprising a wiring connected to the driving wire for use as an electrical path for applying a current to the wire member.

17. An optical image stabilizer (OIS), comprising:
a first wire coupler disposed on a fixed frame and comprising a first tapered insertion space;
a second wire coupler disposed on a movable body and comprising a second insertion space tapered toward the first wire coupler;
a shape memory alloy wire comprising a first tapered coupler and a second tapered coupler spaced apart from each other and tapered toward each other,
wherein the first tapered insertion space is tapered toward the second tapered insertion space,
wherein the first and second tapered couplers are engaged in the first and second tapered insertion spaces, respectively, and
wherein when a current flows through the shape memory alloy wire, the shape memory alloy wire changes shape, moving the movable body in a direction to bring the first and second wire couplers closer to each other.

18. The OIS of claim 17, wherein each of the first and second couplers comprises a tube formed in a conical pipe shape, and a filler filled in the tube, and
wherein the shape memory alloy wire is fixed to the first and second couplers by penetrating through the respective fillers.

19. The OIS of claim 17, further comprising an elastic support disposed between the movable body and the fixed frame that elastically deforms as the movable body moves to provide a restoring force to the movable body.

20. A camera module comprising:
the OIS of claim 17; and
an optical member disposed on the movable body,
wherein the optical member includes an image sensor, a lens barrel, or an image sensor and a lens barrel.
